(19) United States
(12) Patent Application Publication
(10) Pub. No.: US 2014/0036357 A1
(43) Pub. Date: Feb. 6, 2014

(54) MICROSCOPE TUBE HAVING ROTARY JOINTS

(71) Applicant: LEICA MICROSYSTEMS (SCHWEIZ) AG, HEERBRUGG (CH)

(72) Inventors: Michael Güntert, Heerbrugg (CH); Ralf Körber, Zurich (CH)

(73) Assignee: LEICA MICROSYSTEMS (SCHWEIZ) AG, HEERBRUGG (CH)

(21) Appl. No.: 13/952,629

(22) Filed: Jul. 28, 2013

(30) Foreign Application Priority Data
Aug. 1, 2012 (DE) 10 2012 213 606.1

(51) Int. Cl. G02B 21/00

(52) U.S. Cl. CPC G02B 21/00
USPC 359/368

(57) ABSTRACT

The present disclosure relates to a microscope tube comprising at least three tube parts (31, 32, 33) and at least two rotary joints (2, 3, 4, 5), for providing a rotation capability of the tube parts (31, 32, 33) with respect to one another and around rotation axes (10, 11, 28) extending at least in part not parallel to one another, having a brake (7) for locking one of the rotary joints (3), at least one further of the rotary joints (2, 4, 5) being lockable by a coupling element (27, 37) impingeable upon by the brake (7), the coupling element (27, 37) including an angle linkage.

### CROSS REFERENCE TO RELATED APPLICATIONS

This application claims priority of German patent application number 10 2012 213 606.1 filed Aug. 1, 2012, the entire disclosure of which is incorporated by reference herein.

### FIELD OF THE DISCLOSURE

The present disclosure relates to a microscope tube, and particularly, a microscope tube having at least two rotary joints.

### BACKGROUND OF THE DISCLOSURE

DE 33 33 471 C2 discloses a surgical microscope having an observation tube for the principal surgeon and a second observation tube for the assistant. The co-observer's tube for the assistant comprises two rotary articulation points; the eyepiece viewing port is rotatable 360° relative to a base part of the co-observer's tube, the co-observer's tube being received with said base part on the surgical microscope. The co-observer's tube itself is rotatable, around a second rotary articulation point, around the optical axis of the principal observer's tube. By means of corresponding rotary joints at these rotary articulation points, the assistant can bring his eyepiece viewing port into a position that is ergonomically favorable for him.

In this existing art, positioning of the tube parts linked by the rotary joints is effected via friction. Frictional forces consequently prevent independent displacement once positioning has occurred. Inadvertent displacement due to small forces is also intended to be avoided. On the other hand, however, the need exists for an ability to position the tube parts using small forces, in particular so that repositioning can be carried out during an operation without a large energy expenditure. The result of these mutually contradictory demands is in practice that large initial forces are needed in order to displace the tube parts, so that the large frictional forces in the rotary joints can be overcome. The result of this in turn is that fine-scale positioning operations, i.e. small displacements of the tube parts, cannot be performed with high accuracy.

DE 101 44 033 A1 proposes a tube for a microscope having at least two rotary joints, said rotary joints each being lockable by means of brakes. Provided for releasing said brakes is a shared operating lever, upon the actuation of which both rotary joints (all rotary joints in the case of more than two rotary joints) are disengaged. When the brakes are immobilized, inadvertent swiveling of the tube parts at the rotary joints is consequently precluded. When swiveling is desired, however, the user does not need to apply large initial forces as discussed above, but instead can, by corresponding actuation of the operating element, release all the brakes so that the rotary joints are no longer immobilized or blocked, so that swiveling can occur with very little energy expenditure.

The object of the disclosure is thus to enable precise and at the same time maximally easy displaceability in the context of a microscope tube comprising rotary joints.

### SUMMARY OF THE DISCLOSURE

The microscope tube according to the present disclosure is operable in a simple, reliable, and ergonomic manner. In particular, the number of brakes can be reduced as compared with conventional approaches, since according to the present disclosure two, three, or more rotary joints of a microscope tube are lockable by means of a single brake and using coupling elements interacting therewith.

According to the present disclosure the coupling elements are embodied as angle linkages or angle coupling elements. Such coupling elements make possible a mechanical deflection of a blocking or locking of one rotation axis onto a further rotation axis extending, for example, perpendicular thereto. Hollow-shaft designs are usable in favorable fashion in the context of transferring such a blocking to multiple further rotation axes. Bevel gear linkages may be mentioned as preferred angle linkages.

Advantages result therefrom in connection with the physical arrangement of the brake. In addition, an embodiment of a microscope tube having only one brake is substantially smaller in size and lighter than conventional approaches.

Advantageous embodiments are described throughout the disclosure.

Advantageously, two further rotary joints are lockable by means of coupling elements respectively impingeable upon by the brake. This makes it possible to hold a microscope tube, preferably comprising three tube parts, in a desired position with actuation of a single brake.

Expediently, the brake is actuatable, i.e. lockable and releasable, via an operating element, such that a locking or releasing of the brake brings about a decoupling of the coupling elements actuatable by the brake.

It is particularly preferred that in the unactuated state, the brake locks or blocks at least some of the rotary joints, in particular all the rotary joints. This ensures very easy handling of the microscope tube, since the brake needs to be actuated, i.e. released, only in the case in which displacement is desired.

Advantageously, a desired minimum torque for swiveling of the rotary joints is settable via the coupling elements. It is thereby possible, for example, to comply in simple fashion with a user's wishes.

In similar fashion, it is possible to set a desired minimum torque for swiveling of the rotary joints via the brake.

Advantageously, the coupling elements are embodied for positive or frictionally engaged force or energy transfer.

Advantageously, the brake utilized according to the present disclosure is embodied as a disk brake or multiple-disk brake. It is possible here, for example when a multiple-disk brake is used, to allocate various disks to corresponding different rotary axes.

Further advantages and embodiments of the disclosure are evident from the description and from the appended drawings.

It is understood that the features recited above and those yet to be explained below are usable not only in the respective combination indicated, but also in other combinations or in isolation, without departing from the scope of the present invention.

The disclosure is schematically depicted in the drawings on the basis of an exemplifying embodiment and will be described in detail below with reference to the drawings.

### BRIEF DESCRIPTION OF THE DRAWINGS

FIG. 1 is a schematic longitudinal section through a first embodiment of a microscope tube according to the present disclosure;

FIG. 2 is a functional sketch for further explanation of the mode of operation of the embodiment according to FIG. 1;

FIG. 3 is a longitudinal section through a second preferred embodiment of a microscope tube according to the present disclosure; and

FIG. 4 is a functional sketch for further explanation of the mode of operation of the embodiment according to FIG. 3.

The Figures will be explained below in overlapping fashion. Identical reference characters designate identical or similar elements.

### DETAILED DESCRIPTION OF THE DISCLOSURE

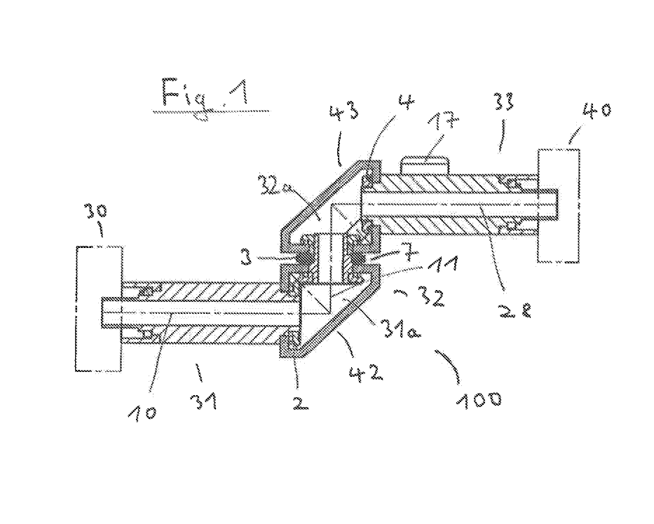

FIG. 1 is a schematic longitudinal section through a first preferred embodiment of a microscope tube 100 according to the present disclosure having three tube parts 31, 32, 33. The reference numeral 30 designates a microscope connector by which microscope tube 100 is secured on the microscope. Connected thereto is first tube part 31, which is connected via a first connecting element 42 to second tube part 32, which in turn is connected via a second connecting element 43 to third tube part 33.

Third tube part 33 serves to receive an assistant's eyepiece 40 (depicted schematically). The longitudinal section that is depicted also shows (dashed line) the profile of an assistant's beam path through microscope tube 1. The assistant's beam path coupled out of the main beam path of the microscope passes through tube lenses and prisms (not depicted). In particular, deflection occurs at deflection elements 31a, 32a that are provided in connecting elements 42 and 43, respectively, in order to allow passage through the tube and to create a split into two beam paths before the assistant's eyepiece. The assistant thus obtains a pseudostereoscopic view into the microscope. Further details regarding the optics described will not be presented here, since they are not relevant to the present disclosure.

By means of connecting elements 42, 43 that comprise rotary joints 2, 3, 4, the corresponding tube parts 31, 32, 33 are rotatable around three rotation axes 10, 11, 28 extending along their respective longitudinal dimensions.

In the depiction according to FIG. 1, first rotation axis 10 extends horizontally and enables a rotation of tube parts 32, 33 around said rotation axis in order to adjust, in particular, the viewing height into microscope tube 100. The corresponding rotary joint is labeled 2. Second rotation axis 11 extends perpendicular to first rotation axis 10 and in a vertical direction as depicted in FIG. 1. It enables a rotation of tube part 33 around said second rotation axis 11 and thus serves for adjustment of the viewing direction into microscope tube 100. The corresponding rotary joint is labeled 3. Third rotation axis 28 extends in a plane that is oriented parallel to the plane of first rotation axis 10, and thus likewise in a horizontal direction as depicted in FIG. 1. It enables a rotation of tube part 33 around said third rotation axis 28 and thus serves in particular to adjust eyepiece viewing in accordance with the head tilt of the assistant, thus enabling a change in the tilt angle of the stereo base of the assistant's eyepiece. The corresponding rotary joint is labeled 4.

Merely for the sake of completeness, it is worth emphasizing that the basic principles explained here are applicable not only to an assistant's tube but instead in general to any microscope tube.

A brake 7, actuatable by means of an actuation element 17, is provided between the two connecting elements 42, 43 on second tube part 32. By means of this brake 7, firstly a swiveling capability of second connecting element 43 and thus of third tube part 33 around second tube axis 11 is lockable or blockable. Expediently, this locking is provided in the non-actuated state of brake 7. In order to bring about a rotation of tube part around axis 11, brake 7 must be correspondingly released.

The present disclosure is notable for the fact that by means of brake 7 acting on second rotation axis 11 and on second tube part 32, respectively, a blocking of the swiveling capability of the tube in further rotation axes can also be ensured. To achieve this, the braking action of brake 7 is deflected or transformed onto at least one further axis that extends perpendicularly to the (second) axis on which brake 7 acts.

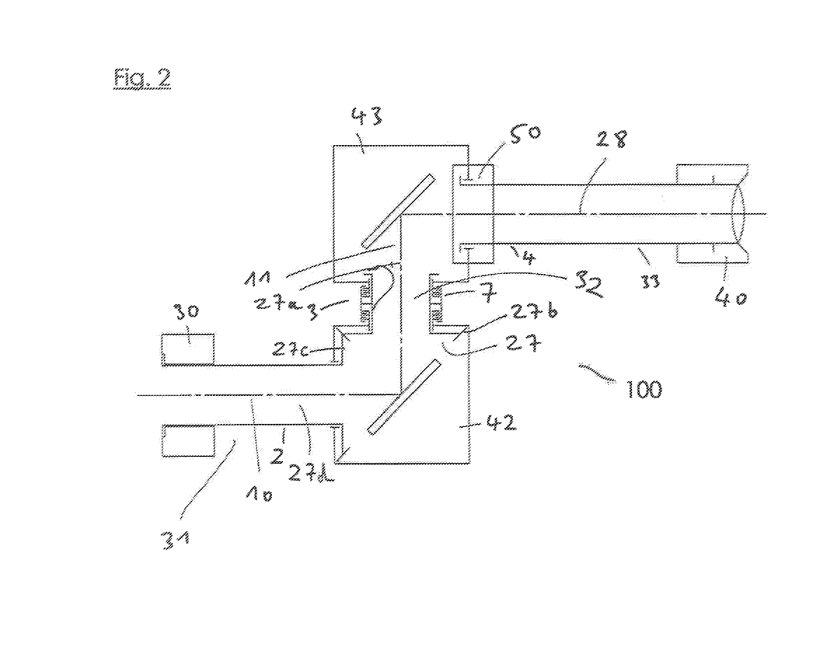

According to the first preferred embodiment, such a deflection of the braking action occurs only from second axis 11 onto first axis 10, as will be explained below with reference to FIG. 2. FIG. 2 once again schematically depicts those components of the microscope tube which are relevant to this. Evident in particular in FIG. 2 is a coupling mechanism 27, embodied as an angle linkage that transfers the locking or blocking action of brake 7 from second tube axis 11 onto first tube axis 10.

Brake 7 is provided as a controllable friction brake, for example as a disk brake or multiple-disk brake.

In the non-actuated state, a rotary motion of a first shaft 27a of coupling mechanism 27 around axis 11, or around an axis extending parallel thereto, is blocked by friction brake 7. A first bevel gear 27b mounted nonrotatably on first shaft 27a is thus likewise blocked. First bevel gear 27b is in working engagement with a second bevel gear 27c. Second bevel gear 27c is in turn connected nonrotatably to a shaft 27d that extends along axis 10 of first tube part 31 (or parallel to said axis), i.e. perpendicularly to shaft 27a. Bevel gears 27b, 27c that are at an angle to one another, preferably at a 90° angle, thus form a bevel gear linkage.

First tube part 31 is thus, as explained, nonrotatably coupled to second bevel gear 27c. The consequence of this is that when first bevel gear 27b is blocked, a corresponding blocking of second bevel gear 27c is produced, with the result that first tube part 31 (or axis 10) is also blocked or locked with respect to second tube part 32 (or axis 11).

The overall result is thus that a locking of brake 7 causes a blocking of axis 11 and of axis 10 extending perpendicular thereto. This approach is advantageous in that only one brake, which can be positioned at a suitable location in tube 100, is needed. Angle linkages have very small dimensions, so that improved overall space utilization can be made available.

In the first embodiment depicted in FIGS. 1 and 2, third tube part 33 is provided with a further brake 50 that is actuatable independently of brake 7.

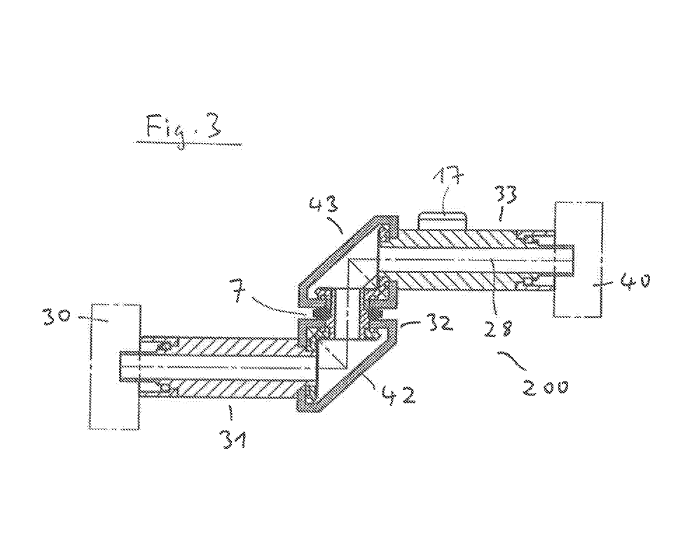

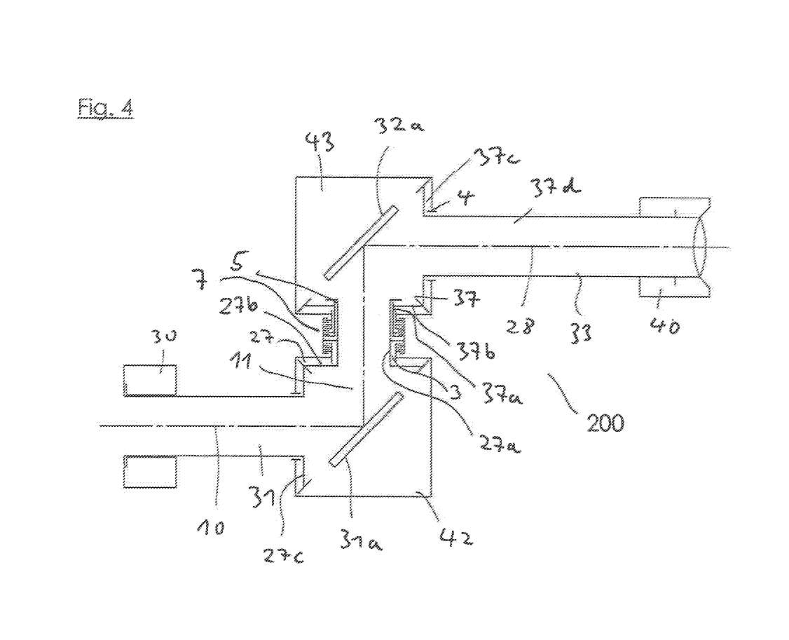

A further preferred embodiment of the disclosure is depicted in FIGS. 3 and 4 and designated in its entirety as 200. This embodiment differs from the one just described in that third axis 28 or third tube part 33 is also equipped with a second coupling element 37 (once again embodied as an angle linkage), so that blocking of brake 7 also makes possible blocking of axis 28 and of third tube part 33. By analogy with angle drive 27, angle drive 37 likewise comprises two first and second bevel gears 37b, 37c coupled to the second and third tube parts. First bevel gear 37b is mounted nonrotatably on a shaft 37a. The shaft can be provided as a hollow shaft and can concentrically surround first shaft 27a via a fourth rotary joint 5. The second bevel gear is nonrotatably connected to a shaft 37d that extends along third axis 28. Rotary joints 3 and 5 are thus oriented coaxially with respect to axis 11.

Be it noted that both brake 7 and the coupling elements (angle linkage) can be embodied in positive or frictionally engaged fashion. The positive engagement selected in angle linkages 27, 37 in the exemplifying embodiments depicted is presented merely by way of example.

The present disclosure enables precise positioning of a microscope tube, in particular of an assistant's tube, in a surgical microscope with little force or energy expenditure and without the danger of inadvertent displacement.

The invention is not to be limited to the specific embodiments disclosed, and modifications and other embodiments are intended to be included within the scope of the invention.

### PARTS LIST

2 First rotary joint

3 Second rotary joint

4 Third rotary joint

5 Fourth rotary joint

7 Brake

10 First tube axis

11 Second tube axis

17 Actuation element

27 Coupling mechanism

27a Shaft

27b Bevel gear

27c Bevel gear

27d Shaft

28 Third tube axis

30 Microscope connector

31 First tube part

31a Deflection element

32 Second tube part

32a Deflection element

33 Third tube part

37 Coupling mechanism

37a Shaft

37b Bevel gears

37c Bevel gears

40 Assistant's eyepiece

42 First connecting element

43 Second connecting element

100 Microscope tube

200 Microscope tube

What is claimed is:

1. A microscope tube, comprising:
at least three tube parts (31, 32, 33);
at least two to four rotary joints (2, 3, 4, 5), for providing a rotation capability of the tube parts (31, 32, 33) with respect to one another and about rotation axes (10, 11, 28) extending at least in part not parallel to one another; and
a brake (7) for locking one of the rotary joints (3);
wherein at least one further of the rotary joints (2, 4, 5) is lockable by coupling elements (27, 37), impingeable upon by the brake (7);
wherein the coupling elements are configured to transfer the braking effect of the brake (7) acting on the one of the rotary joints (3) to at least one other of the at least two to four rotary joints, the coupling elements (27, 37) including angle linkages.

2. The microscope tube according to claim 1, wherein the angle linkages are bevel gear linkages comprising bevel gears (27b, 27c; 37b, 37c).

3. The microscope tube according to claim 1, wherein two further rotary joints (2, 4, 5) are lockable by the coupling elements (27, 37) respectively impingeable upon by the brake (7).

4. The microscope tube according to claim 1, wherein in an unactuated state, the brake (7) blocks at least some of the rotary joints (2, 3, 4, 5).

5. The microscope tube according to claim 1, wherein a desired minimum torque for swiveling the rotary joints (2, 3, 4, 5) is settable via the coupling elements (27, 37).

6. The microscope tube according to claim 1, wherein a desired minimum torque for swiveling of the rotary joints (2, 3, 4, 5) is settable via the brake (7).

7. The microscope tube according to claim 1, wherein the coupling elements (27, 37) are provided for positive or frictionally engaged energy transfer.

8. The microscope tube according to claim 1, wherein the brake (7) is a disk brake or a multiple-disk brake.
